(19) United States
(12) Patent Application Publication
(10) Pub. No.: US 2003/0189921 A1
(43) Pub. Date: Oct. 9, 2003

(54) Device and method for connecting terminals to proprietary signaling to any switching center

(76) Inventor: Peter Handel, (US)

Correspondence Address: MORRISON & FOERSTER LLP, 1650 TYSONS BOULEVARD, SUITE 300, MCLEAN, VA, 22102, US

(21) Appl. No.: 10/363,384

(22) PCT Filed: Sep. 3, 2001
(86) PCT No.: PCT/DE01/03371

(30) Foreign Application Priority Data
Sep. 4, 2000 (DE) 100 43 478.9

(51) Int. Cl. H04M 7/00; H04L 12/66

(52) U.S. Cl. 370/352; 379/229

(57) ABSTRACT

The invention relates to a method for transmitting proprietary signalings between a terminal (1) and a switching center (5, 8) in a telecommunications network (6) for controlling features, whereby the terminal (1) is connected to a first switching center (7), and the proprietary signalings are transmitted between the terminal (1) and a second switching center (5, 8) via a first user data channel (11). The invention also relates to a terminal (1), a switching center (5) and to a communications system (13) for implementing said method.

The invention relates to a method for transmitting proprietary signally between a terminal and a switching center in a telecommunication network and devices for implementing said method.

Standardized signaling is exchanged between a terminal (e.g. telephone, PC) and a switching center in a telecommunication network for control of features and for call control. In the ISDN transmission system, user data (e.g. voice) is transmitted via a user data channel (ISDN-B channel) and the signaling via a signaling channel (ISDN-D channel). Examples of this are signaling for call setup and cleardown, charging information and activating/deactivating call forwarding.

If features are required going beyond the scope of the standard, a suitable proprietary (i.e. application- or company-specific) signaling between the terminal and a switching center is necessary. A precondition for this is that both the terminal and the switching center support this proprietary signaling.

Such features are, for example, required for call center applications where a customer calls a company, for example a bank, insurance company or airline company, to obtain information or advice. The calling customer is then connected to an advisor (agent) of the company.

For an application of this kind, proprietary signaling, e.g. statistical data, information on the availability of agents or signaling to switch a supervisor to an existing connection, must often be exchanged between a switching center and a connected terminal (e.g. a terminal of the agent).

In accordance with the prior art, either the particular user (in this example the company operating the call center) has, with his terminals that support the proprietary signaling, his own telecommunication system that also supports this proprietary signaling, or these terminals are connected directly to a switching center that supports this proprietary signaling.

The object of this invention is therefore to provide a method for the transmission of proprietary signaling and devices for implementing the method, with the connection of terminals with proprietary signaling to any switching centers being enabled.

This object is achieved by a method for transmitting proprietary signals in accordance with the accompanying claim 1, a terminal in accordance with the accompanying claim 4, a switching center in accordance with the accompanying claim 7 and a communication system in accordance with the accompanying claim 9.

In accordance with this invention, proprietary signaling is transmitted between a terminal that transmits propriety signaling and is connected to a conventional first switching center (switching center that does not support the proprietary signaling), and a second switching center that supports the propriety signaling is tunneled via a first user data channel, i.e. in that the data for proprietary signaling is transmitted via a first user data channel (e.g. ISDN-B channel) between the terminal and the second switching center through the telecommunication network.

The advantage of the method in accordance with the invention is that operation of a terminal with proprietary signaling is independent of location, i.e. is independent of whether the signaling center or the telecommunication system supports the proprietary signaling; the terminal obtains access via a first switching center in the telecommunication network that merely supports standard signaling (e.g. for connection setup and cleardown of the user data channels).

In the example of the call center application, consultant stations established in different locations can thus be realized, for example the particular consultants (agents) could work from home.

In accordance with this invention, a terminal, e.g. a PC (personal computer) is provided with proprietary signaling that by means of a terminal signaling device exchanges proprietary signaling with the second switching center via a first user data channel.

In a first realization of this invention, a switching center in accordance with the invention is provided that enables the transmission of signaling via a first user data channel. For this purpose, the switching center in accordance with the invention contains a switching center signaling interface for transmission of the proprietary signaling between the terminal in accordance with the invention and this switching center. In this case, the switching center in accordance with the invention is identical to the second switching center, i.e. in that it supports the proprietary signaling.

In a second realization of this invention, instead of the switching center in accordance with the invention with a switching center signaling interface, a communication system for a switching center with a second switching center is used, with the second switching center supporting the proprietary signaling.

In this case, the communication system has a first signaling interface for transmission of the proprietary signaling between the terminal in accordance with the invention and the second switching center via a first user data channel (e.g. ISDN-B channel), and a second signaling interface for transmission of the proprietary signaling between the communication system and the second switching center via a signaling channel (e.g. ISDN-D channel).

Advantageous embodiments of this invention are given in the relevant subclaims.

The terminal in accordance with the invention advantageously has a terminal data transmission device for data transmission via a second user data channel. This data transmission device can, for example, be designed in the form a telephony device, so that voice is transmitted via the second user data channel.

Furthermore, the terminal in accordance with the invention has a standard signaling interface for transmission of standard signaling between the terminal and the first switching center to which the terminal is connected and which does not support the proprietary signaling. This standard signaling is required for signaling that concerns the first and second user data channel, e.g. for the setup and cleardown of the user data channels. In the realization of this invention with the switching center in accordance with the invention, i.e. the switching center with the switching center signaling interface, the switching center in accordance with the invention has a switching center data transmission device for transmission of user data via a second user data channel.

For the realization of this invention with the communication system in accordance with the invention that is connected to a second switching center that supports the proprietary signaling, the communication system in accordance with the invention has a switching device for switching the second user data channel between the terminal and the second switching center.

The communication system in accordance with the invention in this case consists of a router with the first signaling interface and a router interface and a gateway server with the second signaling interface and a gateway interface. The necessary data transmission between the router and gateway server takes place in each case via the router interface or gateway interface as appropriate.

This invention is further explained using preferred exemplary embodiments, with reference to the accompanying drawings. These are as follows:

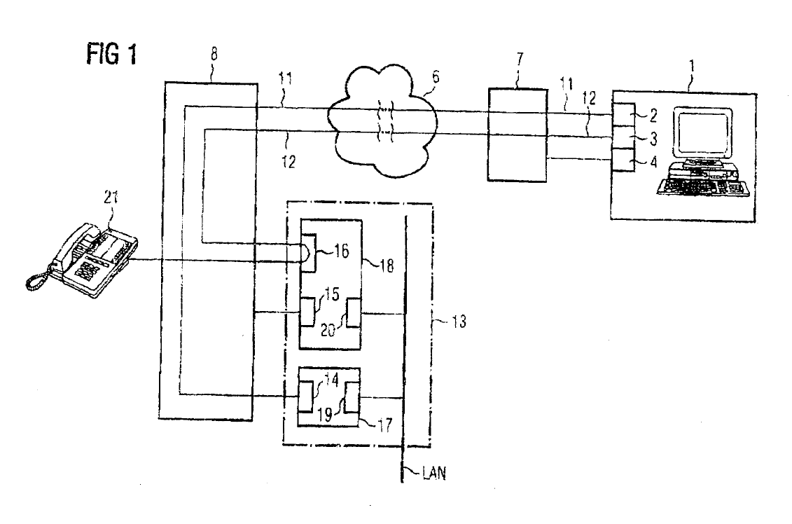

FIG. 1 A schematic representation of the realization of this invention with a communication system in accordance with the invention.

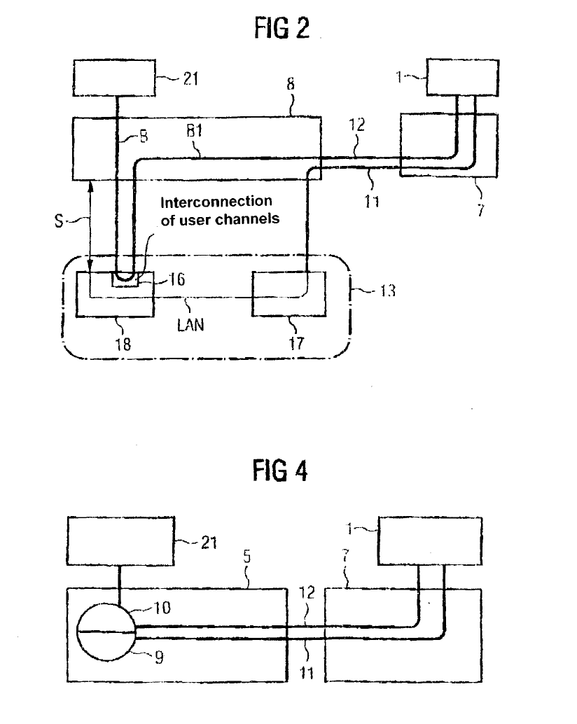

FIG. 2 A representation of user data channel and signaling channel connections.

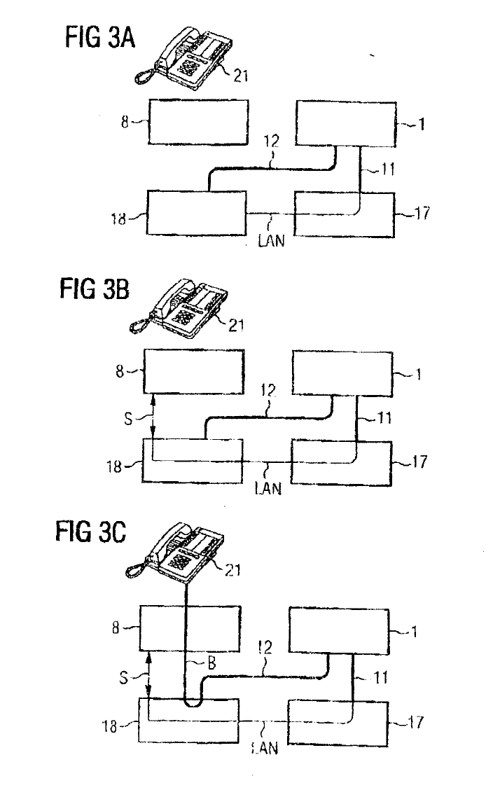

FIGS. 3a to 3c A schematic representation of the setup of a connection, and

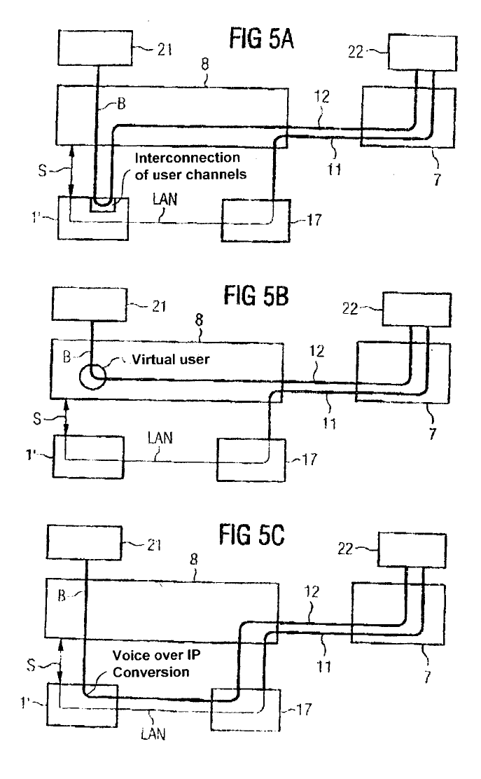

FIGS. 4, 5a to 5c Various realization variants of this invention.

FIG. 1 shows a schematic representation of an embodiment of this invention with a terminal 1 that transmits proprietary signaling and is connected via the first switching center 7 with the telecommunication network 6, with a second switching center 8 that supports proprietary signaling of the end terminal 1 and with the communication system 13 in accordance with the invention.

Two objects are achieved in accordance with this invention, as follows.

Firstly, the proprietary signaling for the first switching center 7, to which terminal 1 in accordance with the invention is connected and that does not support the proprietary signaling, is transmitted transparently between the second switching center 8 and terminal 1, so that the second switching center 8 can treat terminal 1 as a terminal of its own periphery.

Secondly, a user data channel (second user data channel, for example for voice transmission) is switched to terminal 1 (“extended”).

Between terminal 1 in accordance with the invention and the local first switching center 7 only standard signaling with regard to both tunnel connections (first and second user data channels 11 and 12) is signaled, i.e. signaling is transmitted that, for example, is used for the setup or cleardown of the user data channels.

To solve these problems, terminal 1 in accordance with the invention has a terminal signaling device 2 for the transmission of proprietary signaling via a first user data channel 11, a terminal data transmission device 3 for user data transmission (e.g. voice) via a second user data channel 12 and a standard signaling device 4 for transmission of standard signaling between terminal 1 and the first switching center 7, for example to set up and clear down the first and second user data channels between terminal 1 and the first switching center 2.

Furthermore, the communication system 13 connected to the second switching center 8 has a router 17 for transmission of the proprietary signaling and the gateway server 18 for switching a user data channel for transmission of user data (e.g. voice).

The router 17 contains the first signaling interface 14 for transmission of the proprietary signaling via the first user data channel 11 and the router interface for LAN (local area network) for data transmission (i.e. transmission of the proprietary signaling) with the gateway server 18.

The gateway server 18 in turn has a gateway interface 20 to the LAN for data transmission (transmission of the proprietary signaling) with the router 17, the second signaling interface 15 for transmission of the proprietary signaling with the switching center 8 and the switching device 16 for switching the second user data channel 12 with the user data channel of a distant terminal 21; this terminal 21 requires no proprietary signaling.

If, for example, a customer of a company by means of his terminal 21 (distant terminal) calls the call center of the company, then through the communication system 13 a user data connection is on the one hand established between the distant terminal 21 and terminal 1 in accordance with the invention (agent of the company) and on the other hand the proprietary signaling is transmitted via a user data channel between the switching center 8 and terminal 1 in accordance with the invention, by means of the communication system 13.

For the switching center 8, the gateway server 18 thus represents a virtual user who transmits proprietary signaling. The connection of the user data channel and of the proprietary signaling channel takes place from the switching center to the gateway server 18 as for a direct terminal with proprietary signaling connected to the second switching center 8, with the difference that the user data channel for transmission of the user data of a user with the distant terminal 21 is switched through or on by the gateway server 18 to terminal 1 in accordance with the invention.

FIG. 2 is a schematic representation of the user data channel and signaling connections between terminal 1 in accordance with the invention, of the first and second switching center 7 and 8 and a distant terminal 21.

The gateway server 18 has two conventional user data channels (e.g. ISDN Basic Access) for each remote operated terminal 1 in accordance with the invention, as well as via a further user data connection to terminal 1 via router 17.

One of the two user data channels 12 of the gateway server 18 is a conventional connection to terminal 1. The other user data channel is used for connection to a distant terminal 21.

Gateway server 18 has two user data channels for each served terminal 1 in accordance with the invention, that can be interconnected, with a switching of the user data from the distant terminal 21 to terminal 1 in accordance with the invention taking place with a 1 byte delay (approx. 0.13 ms at 64 kBit/s). The interconnection of the two user data channels can, for example, be achieved by means of a digital signal processor (DSP).

The first user data channel 11 is a connection between gateway server 18 and terminal 1 via router 17. The route between gateway server 18 and router 17 is a LAN (e.g. Ethernet) connection. The route between router 17 and terminal 1 in accordance with the invention is a WAN connection (wide area network, e.g. ISDN-B channel). The propriety signaling between the second switching center 8 and terminal 1 is transmitted via this connection or direct data exchange takes place between the second switching center 8 and terminal 1 (signaling S in FIG. 2).

The proprietary signaling with the second switching center 8 is packaged on gateway server 18 in a standard data transmission protocol (e.g. TCP/IP) and is sent via the router 17 to terminal 1 in accordance with the invention, where it is unpacked and processed. In the reverse direction, the signaling is packaged through terminal 1 in accordance with the invention into the standard data transmission protocol and, instead of via the signaling path to the local first switching center 7, is sent via the first user data channel via gateway server 18 (where it is unpacked) to the second switching center 8.

FIGS. 3a to 3c show a schematic representation of a connection setup of both user data channels 11 and 12 and of the signaling channel S.

FIG. 3a: No connection exists between terminal 1 in accordance with the invention and the terminal of the user (distant terminal 21). The first and second user data channels 11 are 12 established. Both these two user channels 11 and 12 can in this case be lease lines, but they can also be set up through terminal 1 in accordance with the invention or set up via the communication system 31 in accordance with the invention (router 17 and gateway server 18) activated by a call from distant terminal 21 to terminal 1.

FIG. 3b: The connection between terminal 1 in accordance with the invention and the standard user terminal (distant terminal 21) is established. The signaling in this case takes place through the first user data channel 11 and the signaling channel S.

FIG. 3c: The user data channel (12 and B) between terminal 1 in accordance with the invention and the distant terminal 21 is active. The second user data channel 12 and the user data channel B of the distant terminal 21 are interconnected at the gateway server 18.

The first user data channel 11 can, as part of a bandwidth increase, also serve for additional transmission of user data in addition to the transmission of proprietary signaling.

Different variants of the realization of this invention are shown in the following using FIGS. 4, 5a to 5c.

FIG. 4 shows the realization whereby the functionality of the router and gateway server are integrated in a switching center 5 (switching center 5 in accordance with the invention as per claim 7), with the switching center 5 in accordance with the invention having a switching center signaling device 9 for transmission of proprietary signaling through a first user data channel 11 and a switching center data transmission device 10 for transmission of user data through a second user data channel 12, which together form the virtual user.

The proprietary signaling is transmitted directly between terminal 1 and the switching center 5 in accordance with the invention. User data channel B of the distant terminal 21 is interconnected in the switching center 5 in accordance with the invention with the second user data channel 12.

FIGS. 5a to 5c show exemplary embodiments, where one terminal 1′ with proprietary signaling is connected directly to the second switching center 8. This terminal 1′ in this case performs the tasks of the gateway server, with the difference that terminal 1′ is remotely controlled from a conventional terminal (remote-controlling terminal 22). In this case, two user data channels (first and second user data channels 11 and 12) are established, with the remote-controlling terminal 22 (e.g. PC) remotely controlling terminal 1′ through the first user data channel 11. The remote control in this case can, for example, take place by means of commercial programs, with which a PC can be remotely controlled from a different remote PC.

FIG. 5a shows the through-switching of the second user data channel with the user data channel B of the distant terminal 21 by means of a switching device.

In FIG. 5b the second user data channel 12 is switched through with the user data channel of the distant terminal 21 through the switching center 8, to which terminal 1′ is connected.

In the examples in FIGS. 5a and 5b, separate terminals (telephone and PC) can also be used as the remote-controlling terminal 22 for the remote control of terminal 1′.

In the example in FIG. 5c, the user data is transmitted via the router 17 (in the case of voice, for example as “Voice over IP”) through an additional channel between the router 17 and terminal 1′ to the remote-controlling terminal 22. The “Voice over IP” conversion can in this case take place either in terminal 1′ or in switching center 8.

Furthermore, in the example shown in FIG. 5c, the complete application can run on a server, terminal 1′ has only a client application (e.g. applets in an Internet browser). There are only IP connections between terminal 1′ and the server. Voice is passed to terminal 1′ using “Voice over IP” (VoIP). The conversion of VoIP can take place either in the switching center 8 or in the server.

1. Method for transmission of proprietary signaling between a terminal (1) and a switching center (5, 8) in a telecommunication network (6) for control of performance features, with
terminal (1) being connected to a first switching center (7) that does not support the proprietary signaling,
standardized signaling being transmitted via a signaling channel and user data via at least one user data channel, and the proprietary signaling between terminal (1) and a second switching center (5, 8) that does support the proprietary signaling being transmitted via a first user data channel (11).

2. Method in accordance with claim 1, characterized in that user data is transmitted between terminal (1) and the second switching center (5, 8) via a second user data channel (12).

3. Method in accordance with claim 2, characterized in that the user data that is transmitted via the second user data channel (12) is voice information.

4. Terminal (1) for implementation of the method in accordance with one of claims 1 to 3, characterized by
a terminal signaling device (2) for transmission of proprietary signaling via a first user data channel (11).

5. Terminal (1) in accordance with claim 4, characterized by a terminal data transmission device (3) for transmission of user data via a second user data channel (12).

6. Terminal (1) in accordance with claim 4 or 5, characterized by
a standard signaling device (4) for transmission of standard signaling between terminal (1) and the first switching center (7).

7. Switching center (5) for implementation of the method in accordance with one of claims 1 to 3, with the switching center (5) supporting proprietary signaling, characterized by a switching center signaling device (9) for transmission of proprietary signaling between a terminal (1) and a switching center (5) via a first user data channel (11).

8. Switching center (5) in accordance with claim 7, characterized by
a switching center data transmission device (10) for transmission of user data via a second user data channel (12).

9. Communication system (13) for a switching center (8) supporting proprietary signaling, for the implementation of the method in accordance with one of claims 1 to 3, characterized by
a first signaling interface (14) for transmission of proprietary signaling between the terminal (1) and the communication system (13) via a first user data channel (11) and
a second signaling interface (15) for transmission of proprietary signaling between switching center (8), that supports the proprietary signaling, and
the communication system (13) via a signaling channel.

10. Communication (13) in accordance with claim 9, characterized by
a switching device (16) for switching a second user data channel (12) between the terminal (1) and the second switching center (8).

11. Communication system (13) in accordance with claim 9 or 10, characterized in that
it includes a router (17) containing a first signaling interface (14) and a router interface (19) for data transmission with a gateway server (18), and has the gateway server (18) that includes the second signaling interface (15) and a gateway interface (20) for data transmission with the router (17).
